(19) United States
(12) Patent Application Publication
(10) Pub. No.: US 2024/0086785 A1
(43) Pub. Date: Mar. 14, 2024

(54) METHOD AND APPARATUS FOR PROVIDING INTEGRATED MANAGEMENT SERVICE FOR ACCOMMODATION

(71) Applicant: ONDA INC., Seoul (KR)

(72) Inventor: Hyunsuck OH, Seoul (KR)

(73) Assignee: ONDA INC., Seoul (KR)

(21) Appl. No.: 18/513,741

(22) Filed: Nov. 20, 2023

Related U.S. Application Data
(63) Continuation of application No. PCT/KR2021/019762, filed on Dec. 23, 2021.

(30) Foreign Application Priority Data
May 25, 2021 (KR) 10-2021-0067266

(51) Int. Cl. G06Q 10/02; G06F 21/31; G06Q 50/12

(52) U.S. Cl. CPC G06Q 10/02; G06F 21/31; G06Q 50/12

(57) ABSTRACT

A method for providing an integrated management service for an accommodation, includes receiving, from an accommodation terminal, room information, and items necessary for room reservation; providing, to a user terminal on the basis of the room information, a list of rooms; receiving, from the user terminal, selection information; receiving, from the user terminal, user information corresponding to the items necessary for room reservation; generating, on the basis of the selection information and the user information, room reservation information and a user corresponding to the user information; providing the room reservation information to the accommodation terminal; receiving approval information for the room reservation information from the accommodation terminal; providing the approval information to the user terminal; receiving, from the user terminal, check-in information necessary for the user to check in to the room; and providing, to the user terminal, a smart key for unlocking a door lock of the room.

### TECHNICAL FIELD

The present invention relates to a method and an apparatus for providing an integrated management service for an accommodation.

### BACKGROUND ART

The contents that will be described below simply provide background information related to one embodiment of the present invention without constituting the related art.

Recently, many people are using accommodations to enjoy their leisure time. It is estimated that the number of rooms in accommodations across the country (Korea) exceeds 1 million, and when small accommodations and cases in which private individuals provide accommodation services without registration are taken into consideration, the number of rooms is expected to far exceed the above numerical value.

A conventional method for reserving a room of an accommodation may include a method for allowing a service user to make a reservation by calling a business establishment desired to be used and checking whether the reservation is available at a desired time, a method for allowing a service user to make a reservation through a travel agency or the like in a case where the service user travels to a specific region or the like, a method for making a reservation by using a computer reservation system, and the like.

Among the above methods, with the development of Internet technology and the spread of communication terminals, the method using the computer reservation system has been widely used. A method for making a reservation for a hotel by using a computer reservation system may include two methods. In other words, there may be a method for opening a homepage or the like on a communication network to enable reservation management through the communication network at a specific hotel, and allowing a service user to access the homepage to make a reservation for an accommodation, and a method for allowing a specific service operator to connect a plurality of hotels into a chain and perform reservation management for a service user by proxy.

Accommodations such as hotels may take room reservations through various methods such as phone reservations, travel agencies, directly opened homepages, and reservation agency sites without using only one of the above methods. However, reservations performed by each of the methods have been individually managed without being subjected to real-time integrated management. Therefore, problems such as redundant reservations or overbooking may occur, and reservation cancellations may not be rapidly processed, which causes dissatisfaction among service users.

### DISCLOSURE

### Technical Problem

An object of the present invention is to provide an integrated management service for an accommodation.

In addition, an object of the present invention is to provide a room reservation service while security of user information is ensured.

Further, an object of the present invention is to provide convenience of not requiring a separate room key to be carried by using a smart key.

### Technical Solution

To achieve the objects described above, according to one embodiment of the present invention, there is provided a method for providing an integrated management service for an accommodation, the method including: receiving room information regarding rooms that are able to be reserved by a user, and items necessary for room reservation from an accommodation terminal; providing a list of the rooms that are able to be reserved to a user terminal based on the room information; receiving selection information regarding one of the rooms included in the list of the rooms from the user terminal; receiving user information corresponding to the items necessary for the room reservation from the user terminal; generating room reservation information for the room and the user corresponding to the user information based on the selection information and the user information; providing the room reservation information to the accommodation terminal; receiving approval information for the room reservation information from the accommodation terminal; providing the approval information to the user terminal; receiving check-in information necessary for the user to check in to the room from the user terminal; and providing a smart key for unlocking a door lock of the room to the user terminal.

The receiving of the user information may include: receiving a first presentation generated based on a first credential including identity authentication information from the user terminal; and performing identity authentication of the user of the user terminal by using the first presentation, the generating of the room reservation information may include issuing, after generating the room reservation information with the identity-authenticated user, a second credential including the room reservation information to the user terminal, the providing of the room reservation information to the accommodation terminal may include: receiving a second presentation generated based on the first credential and the second credential from the user terminal; and providing the second presentation to the accommodation terminal, and the approval information may be information approved by the accommodation by confirming the room reservation information by using the second presentation.

The first credential may be generated from an identity authentication institution to include the identity authentication information of the user and a first signature of the identity authentication institution, the first credential may be removed from the identity authentication institution after being issued to the user terminal, the first signature may be able to be verified by using a first public key stored in an online storage, and the performing of the identity authentication may include performing the identity authentication of the user of the user terminal by using the first presentation and the first public key.

The first presentation may include a second signature generated so as to be able to be verified through the first public key by the user terminal in order to zero-knowledge prove that the first credential includes the first signature.

The issuing of the second credential may include: issuing the second credential including the room reservation information and a third signature of a service provider to the user terminal; storing a second public key capable of verifying the third signature in the online storage; and removing temporarily stored information of the issued second credential.

The receiving of the check-in information may include: receiving a third presentation generated based on the first credential and the second credential from the user terminal; and performing the identity authentication of the user of the user terminal and authentication of the room reservation information by using the third presentation.

The third presentation may be different from the second presentation.

The providing of the approval information may include: providing a payment interface for payment of a price corresponding to the room to the user terminal; and providing, when the payment is completed through the payment interface, the approval information to the user terminal.

After the providing of the smart key, when the check-in is completed by the user, an amount obtained by subtracting a preset fee from the price may be paid to the accommodation.

In addition, according to one embodiment of the present invention, there is provided an apparatus for providing an integrated management service for an accommodation, the apparatus including: a memory in which at least one program is recorded; and a processor for executing the program, wherein the program includes instructions for performing: receiving room information regarding rooms that are able to be reserved by a user, and items necessary for room reservation from an accommodation terminal; providing a list of the rooms that are able to be reserved to a user terminal based on the room information; receiving selection information regarding one of the rooms included in the list of the rooms from the user terminal; receiving user information corresponding to the items necessary for the room reservation from the user terminal; generating room reservation information for the room and a user corresponding to the user information based on the selection information and the user information; providing the room reservation information to the accommodation terminal; receiving approval information for the room reservation information from the accommodation terminal; providing the approval information to the user terminal; receiving check-in information necessary for the user to check in to the room from the user terminal; and providing a smart key for unlocking a door lock of the room to the user terminal.

### Advantageous Effects

According to the present invention, an integrated management services for an accommodation can be provided.

In addition, according to the present invention, a room reservation service can be provided while security of user information is ensured.

Further, according to the present invention, convenience of not requiring a separate room key to be carried can be provided by using a smart key.

### DESCRIPTION OF DRAWINGS

FIG. 1 is a block diagram showing entities for providing an integrated management service for an accommodation according to one embodiment of the present invention.

FIG. 2 is an operation flowchart showing a method for providing an integrated management service for an accommodation according to one embodiment of the present invention.

FIG. 3 is an operation flowchart showing a method for providing an integrated management service for an accommodation according to another embodiment of the present invention.

FIG. 4 is an operation flowchart showing a method for providing an integrated management service for an accommodation according to still another embodiment of the present invention.

FIG. 5 is an operation flowchart showing a method for providing an integrated management service for an accommodation according to yet another embodiment of the present invention.

FIG. 6 is an operation flowchart showing a method for providing an integrated management service for an accommodation according to still yet another embodiment of the present invention.

FIG. 7 is an operation flowchart showing a method for providing an integrated management service for an accommodation according to another embodiment of the present invention.

FIG. 8 is an operation flowchart showing a method for providing an integrated management service for an accommodation according to still another embodiment of the present invention.

FIG. 9 is an operation flowchart showing a method for providing an integrated management service for an accommodation according to yet another embodiment of the present invention.

FIG. 10 is a view showing a computer system according to one embodiment of the present invention.

### MODE FOR INVENTION

The present invention will be described in detail below with reference to the accompanying drawings. In this case, redundant descriptions and detailed descriptions of well-known functions and configurations that may unnecessarily obscure the gist of the present invention will be omitted. Embodiments of the present invention are provided to more completely describe the present invention to a person having ordinary skill in the art. Therefore, shapes, sizes, and the like of elements in the drawings may be exaggerated for a clearer description.

Throughout the present disclosure, when some part “includes” some elements, unless explicitly described to the contrary, it means that other elements may be further included but not excluded.

Hereinafter, exemplary embodiments of the present invention will be described in detail with reference to the accompanying drawings.

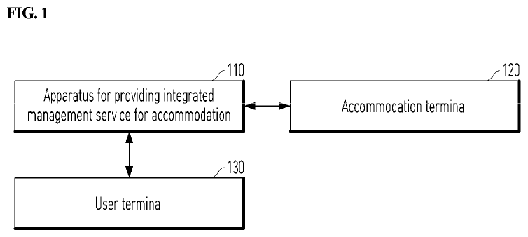

FIG. 1 is a block diagram showing entities for providing an integrated management service for an accommodation according to one embodiment of the present invention.

Referring to FIG. 1, entities for providing an integrated management service for an accommodation according to one embodiment of the present invention may include an apparatus 110 for providing an integrated management service for an accommodation, an accommodation terminal 120, and a user terminal 130.

The apparatus 110 for providing the integrated management service for the accommodation may refer to an apparatus for receiving user information corresponding to items necessary for room reservation from the user terminal 130 to generate room reservation information.

The apparatus 110 for providing the integrated management service for the accommodation may perform a function of a server or a platform for providing an integrated management service for an accommodation.

The accommodation terminal 120 may be a device for providing approval information based on the room reservation information received from the apparatus 110 for providing the integrated management service for the accommodation.

The user terminal 130 may be a device for providing the user information to the apparatus 110 for providing the integrated management service for the accommodation.

The apparatus 110 for providing the integrated management service for the accommodation and the accommodation terminal 120, and the apparatus 110 for providing the integrated management service for the accommodation and the user terminal 130 may be interconnected through a communication network.

The communication network may refer to an access path for allowing data to be transmitted and received between the above entities. For example, the communication network may encompass wired networks such as local area networks (LANs), wide area networks (WANs), metropolitan area networks (MANs), and integrated service digital networks (ISDNs), or wireless networks such as wireless LANs, CDMA, Bluetooth, and satellite communications, but the scope of the communication network that is applicable to the present invention is not limited thereto.

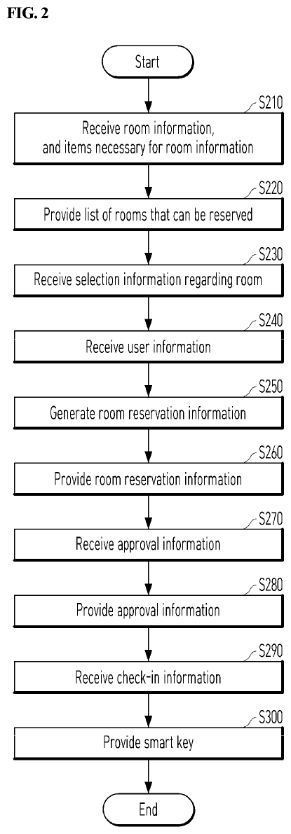

FIG. 2 is an operation flowchart showing a method for providing an integrated management service for an accommodation according to one embodiment of the present invention.

Referring to FIG. 2, according to a method for providing an integrated management service for an accommodation of one embodiment of the present invention, first, an apparatus for providing an integrated management service for an accommodation may receive room information regarding rooms that are able to be reserved by a user, and items necessary for room reservation from an accommodation terminal (S210).

In this case, the room information may include a first price and a lowest price, which are reference prices corresponding to each preset season.

In this case, the first price may refer to a price at which each accommodation desires to sell, and the lowest price may refer to a price set by each accommodation in consideration of a minimum profit.

Next, a list of the rooms that are able to be reserved may be provided to a user terminal based on the room information (S220).

Next, selection information regarding one of the rooms included in the list of the rooms may be received from the user terminal (S230).

Next, user information corresponding to the items necessary for the room reservation may be received from the user terminal (S240).

Next, room reservation information for the room and the user corresponding to the user information may be generated based on the selection information and the user information (S250).

Next, the room reservation information may be provided to the accommodation terminal (S260).

Next, approval information for the room reservation information may be received from the accommodation terminal (S270).

In this case, the approval information may be information approved by the accommodation by confirming the room reservation information by using a second presentation generated by the user terminal based on a first credential and a second credential. The above configuration will be described in detail below with reference to FIGS. 3 to 5.

Next, the approval information may be provided to the user terminal (S280).

Next, check-in information necessary for the user to check in to the room may be received from the user terminal (S290).

Next, a smart key for unlocking a door lock of the room may be provided to the user terminal (S300).

In this case, the smart key may be used to unlock or lock a corresponding smart door lock by interacting with the smart door lock.

According to an optional embodiment, the providing of the list of the rooms to the user terminal (S220) may include: grouping the rooms based on the room information; generating first price information for each of the rooms included in the list of the rooms based on a preset price setting algorithm; and providing the list of the rooms, which includes the first price information, to the user terminal.

For example, the rooms may be grouped into a standard type, a deluxe type, and a suite type according to a grade set for each of the rooms by each accommodation.

As another example, based on the first price set for each of the rooms, the rooms exceeding 500,000 KRW may be grouped into a first group, the rooms exceeding 300,000 KRW and less than or equal to 500,000 KRW may be grouped into a second group, the rooms exceeding 100,000 KRW and less than or equal to 300,000 KRW may be grouped into a third group, and the rooms less than or equal to 100,000 KRW may be grouped into a fourth group. A scheme and prices for grouping the rooms are merely examples according to one embodiment, and do not limit the scope of the present invention.

According to an optional embodiment, the generating of the first price information may include: obtaining a first price for each of the rooms corresponding to a season including first selection information; calculating a first weight based on a remaining period until a start date of a period of the first selection information based on a reservation date; calculating a second price by assigning the first weight to the first price; calculating a second weight based on a preset demand forecasting scheme; and calculating a third price by assigning the second weight to the second price.

In this case, the first weight may be calculated so that the first weight may be gradually increased as the remaining period becomes smaller.

For example, a first weight of 0.5 may be assigned when the remaining period is greater than or equal to 3 months, a first weight of 0.7 may be assigned when the remaining period is greater than or equal to 2 months and less than 3 months, and a first weight of 0.9 may be assigned when the remaining period is greater than or equal to 1 month and less than 2 months. The first weight may not be assigned when the remaining period is less than 1 month. The first weight is merely an example according to one embodiment, and does not limit the scope of the present invention.

In addition, the third price may not be less than the lowest price.

For example, when the lowest price of one of the rooms is 100,000 KRW, and the third price to which the first and second weights are assigned is 80,000 KRW, the third price may be adjusted to 100,000 KRW, which is equal to the lowest price. The price is merely an example according to one embodiment, and does not limit the scope of the present invention.

According to an optional embodiment, the calculating of the second weight may include: calculating an increase/decrease rate of reservations compared to a previous year based on room reservation data for the same period of the previous year; and calculating the second weight based on the increase/decrease rate.

In this case, reservation data for each of the rooms for the same period of the previous year may be obtained for a usage period included in the first selection information. The increase/decrease rate of the reservations compared to the previous year may be calculated by comparing a reservation rate for the period with a current reservation rate on the same date of the previous year as a current reservation date.

For example, when the current reservation date is Jun. 1, 2021, and the usage period included in the first selection information is Aug. 1 to Aug. 5, 2021, data on a reservation rate from Aug. 1, 2020 to Aug. 5, 2020 may be obtained based on Jun. 1, 2020, and the data may be compared with a reservation rate from Aug. 1, 2021 to Aug. 5, 2021 based on Jun. 1, 2021, so that the increase/decrease rate of reservations may be calculated.

In addition, the second weight may be calculated based on search data of users for the past month.

For example, when the usage period included in the first selection information is from Aug. 1, 2021 to Aug. 5, 2021, and a search volume of the users has increased for the usage period in the past month, the second weight may be calculated so that a room usage price for the usage period may be increased.

Accordingly, a demand of the users may be forecasted. When the reservation rate is increased as compared with the previous year, a high demand of the users is determined to exist for the usage period included in the first selection information, and the second weight may be calculated so that the price of the room may be increased.

According to an optional embodiment, even when the search volume of the users is increased for the usage period, a high demand of the users is determined to exist for the usage period, and the second weight may be calculated so that the price of the room may be increased.

According to an optional embodiment, the calculating of the increase/decrease rate may include: calculating a first increase/decrease rate of reservations compared to the previous year corresponding to a first room included in one accommodation among a plurality of accommodations; calculating a second increase/decrease rate of reservations compared to the previous year corresponding to the rooms belonging to a group including the first room among the rooms included in remaining accommodations except for the one accommodation; and calculating a third increase/decrease rate by assigning weights to the first increase/decrease rate and the second increase/decrease rate based on a preset weight assignment scheme.

In this case, the second increase/decrease rate may represent an average of the increase/decrease rate of reservations compared to the previous year corresponding to each of the rooms belonging to the group including the first room.

In addition, the third increase/decrease rate may represent a value obtained by assigning the weights to the first increase/decrease rate and the second increase/decrease rate to correct the first and second increase/decrease rates, and summing up the corrected first and second increase/decrease rates.

For example, when the first increase/decrease rate is 10%, and the second increase/decrease rate is 15%, a weight of 0.8 may be assigned to the first increase/decrease rate to obtain 8%, a weight of 0.2 may be assigned to the second increase/decrease rate to obtain 3%, and the two increase/decrease rates to which the weights are assigned may be summed up to obtain the third increase/decrease rate of 11%. The increase/decrease rates and the weights are merely examples according to one embodiment, and do not limit the scope of the present invention.

According to an optional embodiment, after the calculating of the third price, there may be included: obtaining second price information for each of the rooms provided by a competing service provider; grouping the rooms provided by the competing service provider based on the second price information; and setting the third price to be less than a lowest price among prices corresponding to the rooms provided by the competing service provider belonging to a group having the same level as the group including the first room.

For example, the second price information for rooms included in a suite-type group among the rooms provided by the competing service provider may be obtained. When the lowest price in the second price information is 600,000 KRW, and the third price corresponding to the rooms included in a suite-type group among the rooms provided by the service provider exceeds 600,000 KRW, the third price may be set to 590,000 KRW. The price is merely an example according to one embodiment, and does not limit the scope of the present invention.

According to an optional embodiment, an apparatus for providing a room reservation service may generate a target sales score model of the accommodation based on a room price and a sales rate of the accommodation in the previous year, and dynamically change the price of the room by using the target sales score model.

In this case, a target sales score may be calculated by multiplying a growth rate by a value obtained by multiplying an excess profit and a sales rate, which is obtained by subtracting the lowest price set for the room from the room price in the previous year.

The target sales score model may include target sales scores for each period of a current year to reach the target sales score based on a sales volume for each period in the previous year.

Therefore, the apparatus for providing the room reservation service may calculate a target achievement rate by comparing a current sales score of a specific room with the target sales score for each period, and dynamically change the price of the room based on the target achievement rate.

For example, the apparatus for providing the room reservation service may change the price of the room so that the price of the room may be gradually increased as the target achievement rate increases.

Accordingly, a sales score of the room managed by the apparatus for providing the room reservation service may be adjusted to be close to the target sales score.

According to an optional embodiment, the apparatus for providing the room reservation service may dynamically change the price of the room based on a relative ranking of the target achievement rate for the rooms belonging to the same group.

For example, when a target achievement rate of a first room belonging to a specific group is higher than a target achievement rate of a second room belonging to the same group as the specific group, the apparatus for providing the room reservation service may change a price of the first room to become higher.

Accordingly, a demand for the first room managed by the apparatus for providing the room reservation service may be decreased, and a demand for the second room may be increased, so that the target achievement rates of the first room and the second room may be balanced.

According to an optional embodiment, the apparatus for providing the room reservation service may dynamically change the price of the room based further on a price of the room of the competing service provider belonging to the same group.

For example, when the apparatus for providing the room reservation service changes the price of the first room to become higher in a case where the target achievement rate of the first room belonging to the specific group is higher than the target achievement rate of the second room belonging to the same group as the specific group, the price of the first room may be changed to gradually become higher as a relative value obtained by subtracting a price of a third room of the competing service provider belonging to the same group as the specific group from the price of the first room increases.

According to an optional embodiment, after the calculating of the third price, there may be included: increasing, for a second room belonging to one of groups obtained through the grouping and having a highest reservation rate, when the reservation rate is higher than an average of reservation rates of other rooms in the group except for the second room by a preset rate or more, a price corresponding to the second room by a predetermined rate, and decreasing a price corresponding to each of the remaining rooms in the group except for the second room by the predetermined rate.

For example, when the preset rate is 30%, the reservation rate of the second room is 60%, and the average of the reservation rates of the remaining rooms is 30%, the price of the second room may be increased by 5%, and the prices of the remaining rooms may be decreased by 5%. The rate and the reservation rates are merely examples according to one embodiment, and do not limit the scope of the present invention.

FIG. 3 is an operation flowchart showing a method for providing an integrated management service for an accommodation according to another embodiment of the present invention.

Referring to FIG. 3, according to a method for providing an integrated management service for an accommodation of one embodiment of the present invention, first, an apparatus for providing an integrated management service for an accommodation may receive a first presentation generated based on a first credential including identity authentication information from the user terminal (S310).

In this case, the first credential may be generated from an identity authentication institution to include the identity authentication information of the user and a first signature of the identity authentication institution, and may be removed from the identity authentication institution after being issued to the user terminal. In addition, the first signature may be able to be verified by using a first public key stored in an online storage.

In addition, the first presentation may include a second signature generated so as to be able to be verified through the first public key by the user terminal in order to zero-knowledge prove that the first credential includes the first signature.

In this case, a zero-knowledge proof may refer to a scheme of proving that one knows information without revealing the information one possesses.

Next, identity authentication of the user of the user terminal may be performed by using the first presentation (S320).

In this case, the step S320 may include performing the identity authentication of the user of the user terminal by using the first presentation and the first public key.

Accordingly, the apparatus for providing the integrated management service for the accommodation may not directly receive the identity authentication information of the user from the user terminal or store the identity authentication information, so that the identity authentication information of the user may be safely protected when a server is attacked by a third party.

According to an optional embodiment, the online storage may match and store the first public key and the second signature, and allow checking of redundancy of the second signature to be performed when the apparatus for providing the integrated management service for the accommodation requests the public key, so that a presentation that has been generated once may be prevented from being used a plurality of times.

According to an optional embodiment, the user terminal may receive a selective disclosure request (SDR) from the accommodation terminal, select some of claims included in the second credential to correspond to the selective disclosure request, and generate a presentation. The accommodation terminal may frequently change claim items necessary for generating the room reservation information through the selective disclosure request so as to indirectly check whether the user terminal includes a full text of the second credential.

When it is verified that at least one claim included in the presentation is included in the second credential issued by the apparatus for providing the integrated management service for the accommodation, and a content of the at least one claim indicates that the user terminal has generated the room reservation information with the apparatus for providing the integrated management service for the accommodation, the accommodation terminal may transmit the approval information, which is the information approved by confirming the room reservation information, to the apparatus for providing the integrated management service for the accommodation.

Accordingly, when a fourth signature generated together with the presentation by the user terminal while the presentation is generated does not exist, the accommodation terminal may be prevented from providing the approval information, so that the room reservation information may be prevented from being generated by another user even when the second credential stored in the user terminal is leaked.

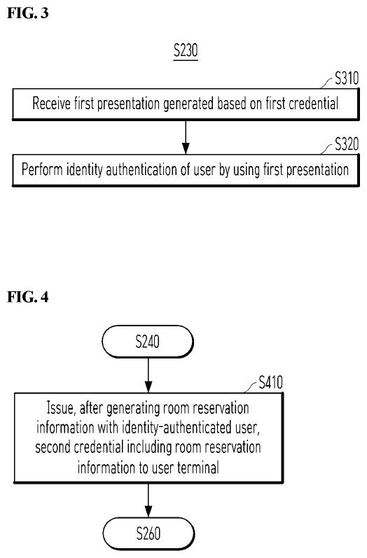

FIG. 4 is an operation flowchart showing a method for providing an integrated management service for an accommodation according to still another embodiment of the present invention.

Referring to FIG. 4, according to a method for providing an integrated management service for an accommodation of one embodiment of the present invention, first, an apparatus for providing an integrated management service for an accommodation may receive the user information, and issue, after generating the room reservation information with the identity-authenticated user, a second credential including the room reservation information to the user terminal (S410).

In more detail, first, the user terminal may transmit the identity authentication information of the user to the apparatus for providing the service.

Next, the user terminal may receive the second credential from the apparatus for providing the service.

The second credential may serve as a certificate for proving that the user terminal has generated the room reservation information for receiving the service, and may include a plurality of claims and a third signature used to issue the second credential.

Regarding the issued second credential, the apparatus for providing the service may store only the public key for proving the third signature and delete the remaining information.

Accordingly, the full text of the second credential issued to the user terminal may not be stored anywhere else, including the apparatus for providing the service, so that the user terminal may have self-sovereignty.

FIG. 5 is an operation flowchart showing a method for providing an integrated management service for an accommodation according to yet another embodiment of the present invention.

Referring to FIG. 5, according to a method for providing an integrated management service for an accommodation of one embodiment of the present invention, first, an apparatus for providing an integrated management service for an accommodation may receive a second presentation generated based on the first credential and the second credential from the user terminal (S510).

Next, the second presentation may be provided to the accommodation terminal (S520).

In more detail, the user terminal may generate a fourth signature based on the third signature included in the second credential while generating the second presentation based on the first credential and the second credential. The apparatus for providing the integrated management service for the accommodation may receive the second presentation including the second signature and the fourth signature from the user terminal, and request the approval information for the room reservation information while transmitting the second presentation to the accommodation terminal.

In this case, the fourth signature may be a signature generated to zero-knowledge prove that the issued second credential includes the third signature. In other words, the fourth signature may be exposed instead of the third signature, and verification may be performed on the fourth signature through the public key to prove that the issued second credential includes the third signature even when the third signature is not exposed.

Accordingly, the accommodation terminal may receive the public key from an external storage in which the public key is stored to verify the second signature and the fourth signature, so that it may be verified whether the at least one claim included in the second presentation is included in the credential issued by the apparatus for providing the service, and whether the content of the at least one claim indicates that the user terminal has generated the room reservation information with the apparatus for providing the service.

Accordingly, the first signature included in the first credential and the third signature included in the second credential issued to the user terminal may be prevented from being exposed, so that security may be improved.

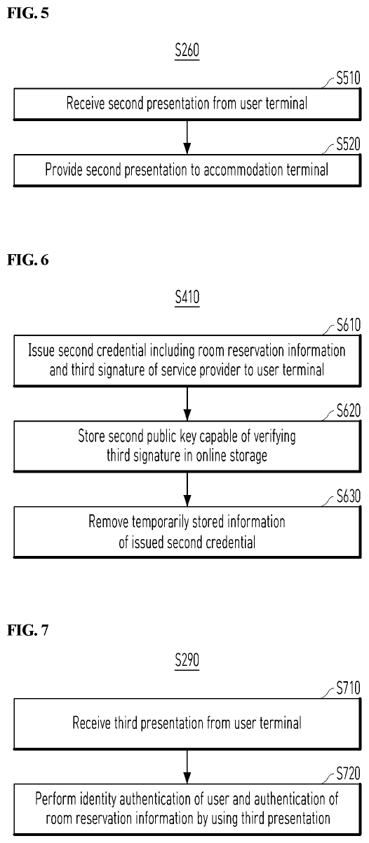

FIG. 6 is an operation flowchart showing a method for providing an integrated management service for an accommodation according to still yet another embodiment of the present invention.

Referring to FIG. 6, according to a method for providing an integrated management service for an accommodation of one embodiment of the present invention, first, an apparatus for providing an integrated management service for an accommodation may issue the second credential including the room reservation information and a third signature of a service provider to the user terminal (S610).

Next, a second public key capable of verifying the third signature may be stored in the online storage (S520).

Next, temporarily stored information of the issued second credential may be removed (S530).

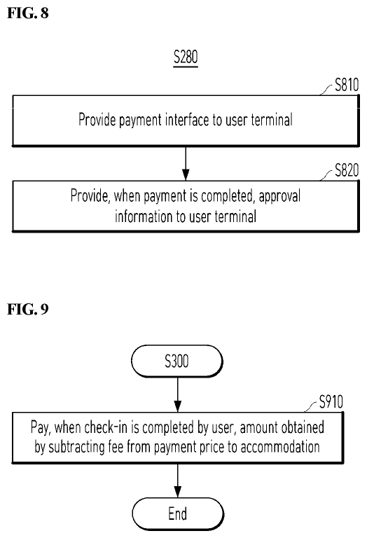

FIG. 7 is an operation flowchart showing a method for providing an integrated management service for an accommodation according to another embodiment of the present invention.

Referring to FIG. 7, according to a method for providing an integrated management service for an accommodation of one embodiment of the present invention, first, an apparatus for providing an integrated management service for an accommodation may receive a third presentation generated based on the first credential and the second credential from the user terminal (S710).

Next, the identity authentication of the user of the user terminal and authentication of the room reservation information may be performed by using the third presentation (S720).

In this case, the third presentation may be different from the second presentation.

FIG. 8 is an operation flowchart showing a method for providing an integrated management service for an accommodation according to still another embodiment of the present invention.

Referring to FIG. 8, according to a method for providing an integrated management service for an accommodation of one embodiment of the present invention, first, an apparatus for providing an integrated management service for an accommodation may provide a payment interface for payment of a price corresponding to the room to the user terminal (S810).

Next, when the payment is completed through the payment interface, the approval information may be provided to the user terminal (S820).

FIG. 9 is an operation flowchart showing a method for providing an integrated management service for an accommodation according to yet another embodiment of the present invention.

Referring to FIG. 9, according to a method for providing an integrated management service for an accommodation of one embodiment of the present invention, first, an apparatus for providing an integrated management service for an accommodation may pay, after the step S300, when the check-in is completed by the user, an amount obtained by subtracting a preset fee from the price to the accommodation (S910).

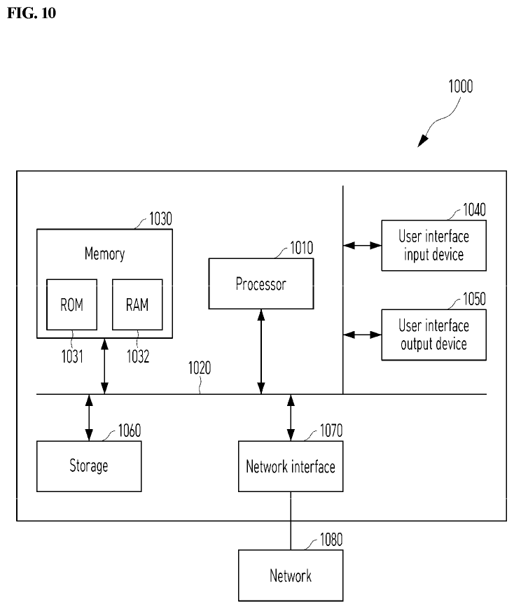

FIG. 10 is a view showing a computer system according to one embodiment of the present invention.

According to one embodiment of the present invention, an apparatus for providing an integrated management service for an accommodation may be implemented in a computer system 1000 such as a computer-readable recording medium.

Referring to FIG. 10, the computer system 1000 may include at least one processor 1010, a memory 1030, a user interface input device 1040, a user interface output device 1050, and a storage 1060, which communicate with each other through a bus 1020. In addition, the computer system 1000 may further include a network interface 1070 connected to a network 1080. The processor 1010 may be a central processing unit or a semiconductor device for executing processing instructions stored in the memory 1030 or the storage 1060. The memory 1030 and the storage 1060 may be various types of volatile or nonvolatile storage media. For example, the memory may include a ROM 1031 or a RAM 1032.

The specific implementations described in the present disclosure are embodiments, and do not limit the scope of the present invention in any way. For brevity of the present disclosure, descriptions of conventional electronic configurations, control systems, software, and other functional aspects of the systems may be omitted. In addition, connections or connection members of lines between elements shown in the drawings illustratively represent functional connections and/or physical or circuit connections, and may be exhibited as various functional connections, physical connections, or circuit connections that are alternative or additional in an actual apparatus. In addition, when there is no specific description such as “essential”, “important”, or the like, the element may not be an essentially necessary element for application of the present invention.

Therefore, the idea of the present invention should not be limited to the embodiments described above, and the scope of the idea of the present invention may encompass the scope of the appended claims as well as all scopes equivalent to the claims or equivalently changed from the claims.

1. A method for providing an integrated management service for an accommodation, the method comprising:
receiving room information regarding rooms that are able to be reserved by a user, and items necessary for room reservation from an accommodation terminal;
providing a list of the rooms that are able to be reserved to a user terminal based on the room information;
receiving selection information regarding one of the rooms included in the list of the rooms from the user terminal;
receiving user information corresponding to the items necessary for the room reservation from the user terminal;
generating room reservation information for the room and the user corresponding to the user information based on the selection information and the user information;
providing the room reservation information to the accommodation terminal;
receiving approval information for the room reservation information from the accommodation terminal;
providing the approval information to the user terminal;
receiving check-in information necessary for the user to check in to the room from the user terminal; and
providing a smart key for unlocking a door lock of the room to the user terminal.

2. The method of claim 1, wherein the receiving of the user information includes:
receiving a first presentation generated based on a first credential including identity authentication information from the user terminal; and
performing identity authentication of the user of the user terminal by using the first presentation,
the generating of the room reservation information includes issuing, after generating the room reservation information with the identity-authenticated user, a second credential including the room reservation information to the user terminal,
the providing of the room reservation information to the accommodation terminal includes:
receiving a second presentation generated based on the first credential and the second credential from the user terminal; and
providing the second presentation to the accommodation terminal, and
the approval information is information approved by the accommodation by confirming the room reservation information by using the second presentation.

3. The method of claim 2, wherein the first credential is generated from an identity authentication institution to include the identity authentication information of the user and a first signature of the identity authentication institution,
the first credential is removed from the identity authentication institution after being issued to the user terminal,
the first signature is able to be verified by using a first public key stored in an online storage, and
the performing of the identity authentication includes performing the identity authentication of the user of the user terminal by using the first presentation and the first public key.

4. The method of claim 3, wherein the first presentation includes a second signature generated so as to be able to be verified through the first public key by the user terminal in order to zero-knowledge prove that the first credential includes the first signature.

5. The method of claim 4, wherein the issuing of the second credential includes:
issuing the second credential including the room reservation information and a third signature of a service provider to the user terminal;
storing a second public key capable of verifying the third signature in the online storage; and
removing temporarily stored information of the issued second credential.

6. The method of claim 2, wherein the receiving of the check-in information includes:
receiving a third presentation generated based on the first credential and the second credential from the user terminal; and
performing the identity authentication of the user of the user terminal and authentication of the room reservation information by using the third presentation.

7. The method of claim 6, wherein the third presentation is different from the second presentation.

8. The method of claim 1, wherein the providing of the approval information includes:
providing a payment interface for payment of a price corresponding to the room to the user terminal; and
providing, when the payment is completed through the payment interface, the approval information to the user terminal.

9. The method of claim 8, wherein, after the providing of the smart key, when the check-in is completed by the user, an amount obtained by subtracting a preset fee from the price is paid to the accommodation.

10. An apparatus for providing an integrated management service for an accommodation, the apparatus comprising:
a memory in which at least one program is recorded; and
a processor for executing the program,
wherein the program includes instructions for performing:
receiving room information regarding rooms that are able to be reserved by a user, and items necessary for room reservation from an accommodation terminal;
providing a list of the rooms that are able to be reserved to a user terminal based on the room information;
receiving selection information regarding one of the rooms included in the list of the rooms from the user terminal;
receiving user information corresponding to the items necessary for the room reservation from the user terminal;
generating room reservation information for the room and a user corresponding to the user information based on the selection information and the user information;
providing the room reservation information to the accommodation terminal;
receiving approval information for the room reservation information from the accommodation terminal;
providing the approval information to the user terminal;
receiving check-in information necessary for the user to check in to the room from the user terminal; and
providing a smart key for unlocking a door lock of the room to the user terminal.
